(19) United States
(12) Patent Application Publication
(10) Pub. No.: US 2026/0311375 A1
(43) Pub. Date: Oct. 8, 2026

(54) METHOD AND APPARATUS FOR MESH DECODING/ENCODING

(71) Applicant: INTELLECTUAL DISCOVERY CO., LTD., Seoul (KR)

(72) Inventors: Jongseok LEE, Seoul (KR); Min Sub KIM, Seoul (KR)

(21) Appl. No.: 19/480,754

(22) PCT Filed: May 20, 2024
(86) PCT No.: PCT/KR2024/006810

§ 371 Date: Oct. 31, 2025

(30) Foreign Application Priority Data
May 19, 2023 (KR) 10-2023-0064811
May 19, 2023 (KR) 10-2023-0064812

(51) Int. Cl. G06T 9/00; G06T 7/11; G06T 17/20; H04N 19/597

(52) U.S. Cl. CPC G06T 9/001; G06T 7/11; G06T 17/20; H04N 19/597; G06T 2200/04; G06T 2207/20021

(57) ABSTRACT

A mesh decoding method and apparatus according to the present disclosure may: receive a bitstream including one or more sub-bitstreams; reconstruct a base mesh of the current patch by decoding a sub-bitstream related to a mesh; reconstruct a difference vector by decoding a sub-bitstream related to a difference vector transform coefficient; and reconstruct a mesh of the current patch on the basis of at least one of the base mesh and the difference vector.

### TECHNICAL FIELD

The present invention relates to an encoder and a decoding apparatus, and more particularly, relates to a method and an apparatus for mesh encoding and decoding.

### BACKGROUND ART

A video image is compressed and encoded by removing spatio-temporal and inter-view redundancy, which may be transmitted over a communication line or stored in a form suitable for storage media.

### DISCLOSURE

### Technical Problem

The present invention proposes a mesh decoding/encoding method and apparatus.

### Technical Solution

A mesh decoding method and apparatus according to the present disclosure may receive a bitstream including one or more sub-bitstreams. Here, the one or more sub-bitstreams may include at least one of a sub-bitstream regarding a mesh, a sub-bitstream regarding a difference vector transform coefficient or a sub-bitstream regarding a texture map.

A mesh decoding method and apparatus according to the present disclosure may reconstruct a base mesh of a current patch by decoding a sub-bitstream regarding the mesh, reconstruct a difference vector by decoding a sub-bitstream regarding the difference vector transform coefficient and reconstruct a mesh of the current patch based on at least one of the base mesh or the difference vector.

In a mesh decoding method and apparatus according to the present disclosure, reconstructing a mesh of the current patch may include performing subdivision on the reconstructed base mesh based on a predetermined subdivision value. Here, the subdivision value may represent the number of the subdivisions.

In a mesh decoding method and apparatus according to the present disclosure, the subdivision value may be signaled from the bitstream in a patch unit.

In a mesh decoding method and apparatus according to the present disclosure, the subdivision value may be signaled from the bitstream based on a patch unit subdivision flag. Here, the patch unit subdivision flag may represent whether a subdivision value in the patch unit is used.

In a mesh decoding method and apparatus according to the present disclosure, the subdivision value may be derived based on a subdivision value of a previous patch and a delta subdivision value signaled for the current patch.

In a mesh decoding method and apparatus according to the present disclosure, the previous patch may refer to a first patch in decoding order or a patch having decoding order immediately before the current patch.

In a mesh decoding method and apparatus according to the present disclosure, any one of a plurality of triangles belonging to the current patch may have a subdivision value different from another one.

In a mesh decoding method and apparatus according to the present disclosure, a subdivision value of a current triangle among the plurality of triangles may be derived based on a subdivision value of a neighboring triangle adjacent to the current triangle.

In a mesh decoding method and apparatus according to the present disclosure, the neighboring triangle may be specified based on information signaled from the bitstream. Here, the information may represent any one of a plurality of neighboring triangles adjacent to the current triangle.

In a mesh decoding method and apparatus according to the present disclosure, a probability table stored in any one of the pre-reconstructed patches may be used as an initial probability table for the current patch.

In a mesh decoding method and apparatus according to the present disclosure, any one of the pre-reconstructed patches may be selected based on reference patch index information signaled through the bitstream.

In a mesh decoding method and apparatus according to the present disclosure, any one of the pre-reconstructed patches may be a patch having decoding order prior to the current patch.

In a mesh decoding method and apparatus according to the present disclosure, the pre-reconstructed patch may belong to a frame different from a current frame to which the current patch belongs, and any one of the pre-reconstructed patches may be a patch having the same patch index as the current patch.

A mesh encoding method and apparatus according to the present disclosure may generate a sub-bitstream regarding a mesh by encoding a base mesh of a current patch, generate a sub-bitstream regarding a difference vector transform coefficient by encoding a difference vector and generate a bitstream including at least one of a sub-bitstream regarding the mesh, a sub-bitstream regarding the difference vector transform coefficient or a sub-bitstream regarding a texture map.

A computer-readable digital storage medium storing video/image information that causes to perform a mesh decoding method according to the present disclosure is provided.

A computer-readable digital storage medium storing video/image information generated according to a mesh encoding method according to the present disclosure is provided.

A method and an apparatus for transmitting video/image information generated according to a mesh encoding method according to the present disclosure are provided.

### TECHNICAL EFFECT

According to a multi-subdivision method proposed in the present invention, the number of subdivisions of a current patch may be predicted from neighboring patches, thereby providing high encoding efficiency for the number of subdivisions of a current patch.

An entropy coding method proposed in the present invention may provide high encoding efficiency by predicting an initial probability value for entropy coding of a current patch and using it for entropy coding of a current patch.

### BRIEF DESCRIPTION OF DRAWINGS

FIG. 1 illustrates a dynamic mesh decoding apparatus according to the present disclosure.

FIG. 2 illustrates a mesh decoding method according to the present disclosure.

FIG. 3 illustrates the patch division of a mesh according to the present disclosure.

FIG. 4 illustrates a connected triangle within a patch as an embodiment according to the present disclosure.

FIG. 5 illustrates subdivision for one triangle according to the present disclosure.

FIG. 6 illustrates a case in which the subdivision value of a current triangle is smaller than the subdivision value of a neighboring triangle.

FIG. 7 illustrates a case in which the subdivision value of a current triangle is smaller than the subdivision value of a neighboring triangle.

FIG. 8 illustrates a case in which the subdivision value of a current triangle is greater than the subdivision value of a neighboring triangle.

FIG. 9 illustrates a case in which there are two neighboring triangles and the subdivision value of a current triangle is smaller than the subdivision value of a neighboring triangle.

FIG. 10 illustrates a 3D patch divided into various sizes.

FIG. 11 illustrates a method for initializing a probability table in a patch unit in a static mesh decoder according to the present disclosure.

FIG. 12 illustrates a method for initializing an optional probability table in a patch unit in a static mesh decoder according to the present disclosure.

FIG. 13 illustrates a method for initializing an adaptive probability table in a patch unit in a static mesh decoder according to the present disclosure.

FIG. 14 illustrates a method for referring to a probability table in a patch unit in a static mesh decoder according to the present disclosure.

### BEST MODE

Referring to drawings attached to this specification, the embodiment of the present invention will be described in detail so that those skilled in the art may easily implement it in the technical field to which the present invention belongs. However, the present invention may be implemented in different forms and is not limited to embodiments described herein. In addition, in order to clearly explain the present invention in drawings, parts that are not related to the description are omitted, and similar drawing signs are attached to similar parts throughout the specification.

Throughout this specification, when a part is referred to as being ‘connected to’ another part, it includes not only a case where it is directly connected, but also a case where it is electrically connected with other elements in between.

In addition, throughout this specification, when a part is referred to as ‘including’ a component, it means that instead of excluding other components, other components may be further included, unless otherwise specifically opposed.

In addition, although terms ‘first’, ‘second’, etc. may be used to describe various components, the components should not be limited by the terms. The terms are used only to distinguish one component from other components.

In addition, in an embodiment regarding a device and a method described in this specification, some configurations of the device or some steps of the method may be omitted. In addition, the order of some configurations of the device or some steps of the method may be changed. In addition, another configuration or another step may be inserted in some configurations of the device or some steps of the method.

In addition, some configurations or some steps in the first embodiment of the present disclosure may be added to the second embodiment of the present disclosure or may be replaced with some configurations or some steps in the second embodiment.

In addition, as construction units shown in an embodiment of the present disclosure are independently shown to represent different characteristic functions, it does not mean that each construction unit is composed in a construction unit of separate hardware or one software. In other words, as each construction unit is described by being enumerated as each construction unit for convenience of a description, at least two construction units of each construction unit may be combined to form one construction unit or one construction unit may be divided into a plurality of construction units to perform a function. The integrated embodiment and separate embodiment of each construction unit are also included in a scope of a right of the present disclosure unless they are beyond the essence of the present disclosure.

First, terms used herein are briefly described as follows.

A video decoding apparatus described below may be an apparatus included in a server terminal such as a civil security camera, a civil security system, a military security camera, a military security system, a personal computer (PC), a laptop computer, a portable multimedia player (PMP), a wireless communication terminal, a smart phone, a TV application server, a service server, etc., and may refer to various apparatus including a user terminal such as various devices, a communication apparatus such as a communication modem, etc. for communicating with a wired or wireless communication network, a memory for storing various programs and data for decoding an image or performing inter or intra prediction for decoding and a microprocessor for executing a program and calculating and controlling the program.

In addition, an image encoded into a bitstream by an encoder may be transmitted to an image decoding apparatus through a wired or wireless communication network such as the Internet, a wireless local area network, a wireless LAN network, a wibro network, a mobile communication network, etc. or through various communication interfaces such as a cable, a universal serial bus (USB), etc. in real time or non-real time and may be decoded, reconstructed and played back as an image. Alternatively, a bitstream generated by an encoder may be stored in a memory. The memory may include both a volatile memory and a nonvolatile memory. In this specification, a memory may be expressed as a recording medium storing a bitstream.

Typically, a video may be composed of a series of pictures, and each picture may be divided into coding units such as blocks. In addition, those skilled in the art to which this embodiment belongs will understand that a term of ‘picture’ described below may be used by being substituted with other terms having the equivalent meaning such as ‘image’, ‘frame’, etc. And, those skilled in the art to which this embodiment belongs will understand that a term of ‘coding unit’ may be used by being substituted with other terms having the equivalent meaning such as ‘unit block’, ‘block’, etc.

Hereinafter, the embodiment of the present invention will be described in more detail by referring to attached drawings. In describing the present invention, the overlapping description of the same components is omitted.

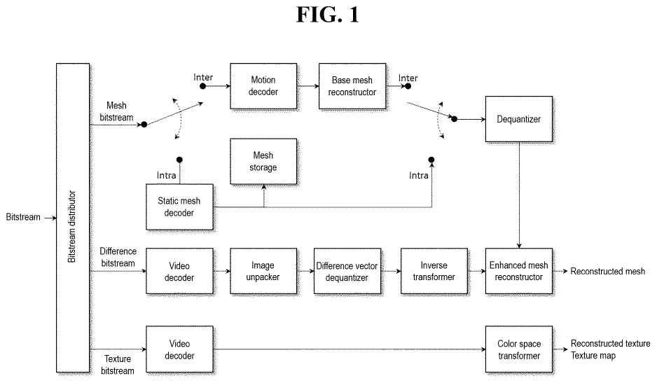

FIG. 1 illustrates a dynamic mesh decoding apparatus according to the present disclosure.

A dynamic mesh decoding apparatus according to the present disclosure may decode a bitstream to reconstruct at least one of a mesh or a texture map.

A dynamic mesh decoding apparatus may include at least one of the bitstream distributor, the motion decoder, the base mesh reconstructor, the static mesh decoder, the mesh storage, the dequantizer, the first video decoder, the second video decoder, the image unpacker, the dequantizer, the inverse transformer, the enhanced mesh reconstructor or the color space transformer.

The bitstream distributor may output a plurality of sub-bitstreams from a bitstream. The plurality of sub-bitstreams may include at least one of a sub-bitstream regarding a mesh (hereinafter, referred to as the first sub-bitstream), a sub-bitstream regarding a difference vector transform coefficient (hereinafter, referred to as the second sub-bitstream) or a sub-bitstream regarding a texture map (hereinafter, referred to as the third sub-bitstream).

The first sub-bitstream may be transmitted to the static mesh decoder and/or the motion decoder. As an example, when a current patch is an intra patch, the first sub-bitstream may be transmitted to the static mesh decoder. Alternatively, when a current patch is an inter patch, the first sub-bitstream may be transmitted to the motion decoder. The second sub-bitstream may be transmitted to the first video decoder. The third sub-bitstream may be transmitted to the second video decoder.

The static mesh decoder may obtain a base mesh from the first sub-bitstream. The base mesh may be transmitted to the mesh storage and/or the dequantizer. In this case, the base mesh may be obtained by using a static mesh compression method based on an Edge-breaker algorithm.

The mesh storage may store the obtained base mesh. In addition, a stored base mesh may be transmitted to the motion decoder and/or the base mesh reconstructor.

The motion decoder may obtain a motion for the vertex of a base mesh based on at least one of the first sub-bitstream or a base mesh. The first sub-bitstream may include motion information for the vertex of a base mesh. Here, motion information may include a motion vector. A motion for the vertex of the base mesh may be transmitted to the base mesh reconstructor.

The base mesh reconstructor may reconstruct the base mesh of a current frame based on at least one of a motion for the vertex of the base mesh or a base mesh transmitted from the mesh storage. Here, the process of reconstructing a base mesh may include the process of adding the vertex coordinates of a base mesh and a motion vector for the vertex of a base mesh. The reconstructed base mesh may be transmitted to the dequantizer.

The dequantizer may perform dequantization on a reconstructed base mesh. As an example, dequantization may be performed on the vertex coordinates of a base mesh. A dequantized base mesh may be transmitted to the enhanced mesh reconstructor.

The first video decoder may obtain a difference image from the second sub-bitstream. In this case, the first video decoder may use a video decoding apparatus equipped with a codec such as H.264/AVC, H.265/HEVC and H.266/VVC. Alternatively, the first video decoder may use an image decoding apparatus equipped with a codec such as PNG, TIF, JPEG, JPEG2000, etc. Information about a decoding apparatus may be included in a bitstream in the form of high-level information. The difference image may be transmitted to the image unpacker.

The image unpacker may obtain a quantized difference vector transform coefficient by extracting each sample value of a difference image according to the pre-defined scan order. A quantized difference vector transform coefficient may be transmitted to the difference vector dequantizer.

Alternatively, a quantized difference vector transform coefficient may also be obtained by entropy decoding the second sub-bitstream without going through the first video decoder and the image unpacker. A quantized difference vector transform coefficient may be transmitted to the difference vector dequantizer.

The difference vector dequantizer may perform dequantization on a quantized difference vector transform coefficient to generate a difference vector transform coefficient. In this case, a quantized difference vector transform coefficient may be a vector having one or more dimensions. Dequantization may be performed by using a different quantization parameter for each dimension. The generated difference vector transform coefficient may be transmitted to the inverse transformer.

The inverse transformer may perform inverse transform on a difference vector transform coefficient to reconstruct a difference vector. Any one of the wavelet transforms may be used for the inverse transform. The reconstructed difference vector may be transmitted to the enhanced mesh reconstructor.

The enhanced mesh reconstructor may reconstruct a mesh based on at least one of a reconstructed base mesh or a difference vector. A reconstructed mesh may be output from a dynamic mesh decoding apparatus.

The second video decoder may generate a texture map by decoding the third sub-bitstream. In this case, the second video decoder may use a video decoding apparatus equipped with a codec such as H.264/AVC, H.265/HEVC and H.266/VVC. Alternatively, an image decoding apparatus equipped with a codec such as PNG, TIF, JPEG, JPEG2000, etc. may be used. Information about a decoding apparatus may be included in a bitstream in the form of high-level information. The generated texture map may be transmitted to the color space transformer.

The color space transformer may perform color space transform on a texture map. In this case, color space transform may be YUV-RGB transform. Alternatively, color space transform may be YCgCo-RGB or YCoCg-RGB transform. A color space-transformed texture map may be output from a dynamic mesh decoding apparatus.

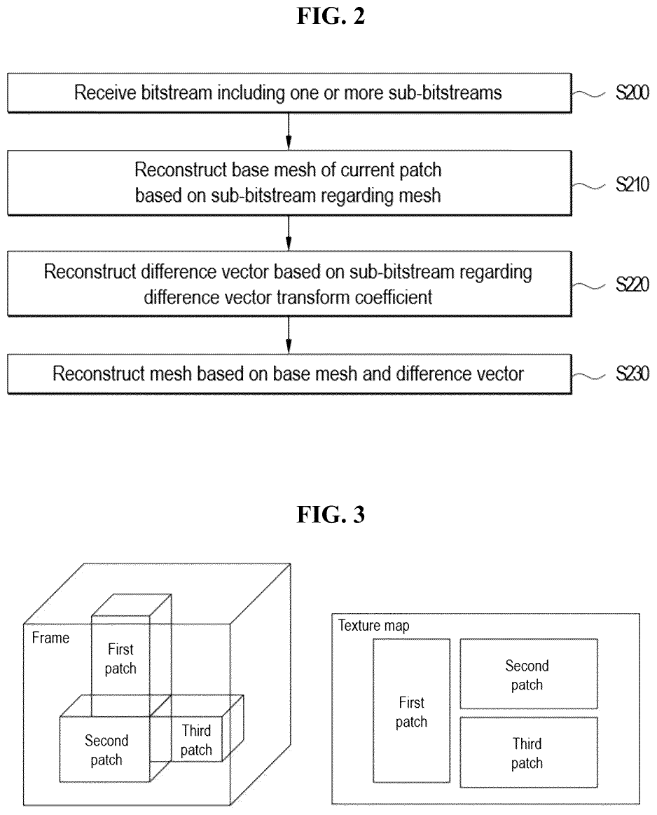

FIG. 2 illustrates a mesh decoding method according to the present disclosure.

Referring to FIG. 2, a bitstream may be received S200.

A bitstream according to the present disclosure may include one or more sub-bitstreams. The one or more sub-bitstreams may include at least one of a sub-bitstream regarding a mesh, a sub-bitstream regarding a difference vector transform coefficient or a sub-bitstream regarding a texture map.

Referring to FIG. 2, a sub-bitstream regarding a mesh may be decoded to reconstruct the base mesh of a current patch S210. A method for reconstructing the base mesh is the same as described by referring to FIG. 1, and a detailed description will be omitted here.

Referring to FIG. 2, a sub-bitstream regarding a difference vector transform coefficient may be decoded to reconstruct a difference vector S220. A method for reconstructing the difference vector is the same as described by referring to FIG. 1, and a detailed description will be omitted here.

Referring to FIG. 2, a mesh may be reconstructed based on at least one of the base mesh or the difference vector. A mesh according to the present disclosure may be reconstructed based on multi-subdivision for the base mesh. Hereinafter, a multi-subdivision method will be described by referring to FIGS. 3 to 9.

FIG. 3 illustrates the patch division of a mesh according to the present disclosure.

A mesh according to the present disclosure may be called a dynamic mesh. Here, a dynamic mesh may be data expressing the surface of a 3D object. In addition, a dynamic mesh may have one or more frames and/or texture maps. The frame may be the geometric information of the outermost surface of a 3D object expressed by connecting a plurality of triangles and the texture map may be the attribute information of the outermost surface of a 3D object. In this case, for each of a frame and a texture map, one or more patches may be generated by grouping a plurality of triangles constituting the outermost surface of a 3D object. Each patch may include a plurality of triangles connected to each other.

A one-to-one mapping between the triangle of a frame and the triangle of a texture map may be possible. A plurality of triangles constituting a texture map may be grouped into a triangle corresponding to each patch of a frame. The same number of patches as frames may be generated for a texture map.

Information about the patch may be transmitted from an encoding apparatus to a decoding apparatus through the high-level information of a bitstream. Here, information about a patch may include the 3D and/or 2D coordinates of a patch. Information about a patch may include the 3D size information and/or 2D size information of a patch.

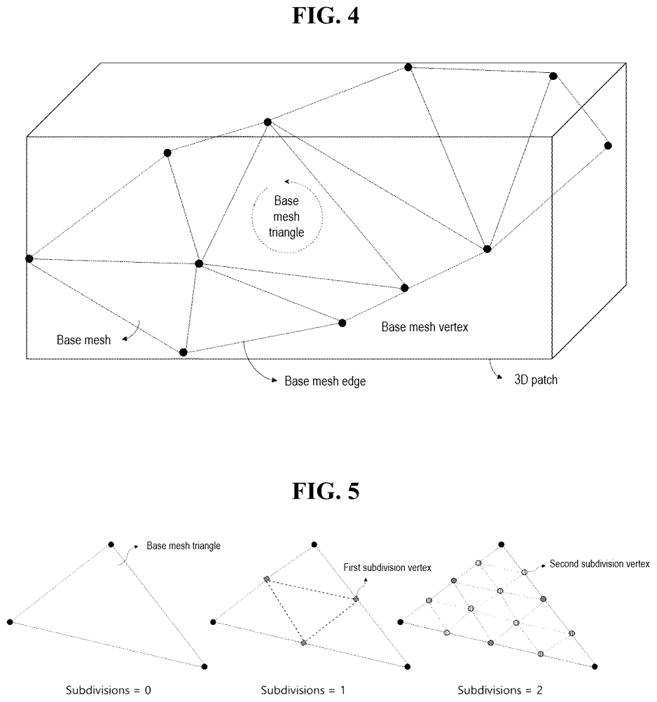

FIG. 4 illustrates a connected triangle within a patch as an embodiment according to the present disclosure.

Referring to FIG. 4, a triangle expressed as a base mesh within a patch is illustrated. One or more base meshes may be included within one 3D patch. A base mesh may have information about a plurality of connected triangles. Each triangle may be composed of a base mesh vertex and a base mesh edge. A base mesh vertex may be defined as a point where two line segments constituting a triangle meet, and a base mesh edge may be defined as a line segment constituting a triangle.

FIG. 5 illustrates subdivision for one triangle according to the present disclosure.

Referring to FIG. 5, the enhanced mesh reconstructor may perform subdivision on a reconstructed base mesh based on a subdivision value. The subdivision value may refer to the number of subdivisions. The number of subdivisions may be referred to as the number of repetitions of subdivisions. Subdivision may be performed recursively and/or hierarchically. As shown in the example of FIG. 5, a subdivision vertex may be generated by subdivision at the middle point of each base mesh edge. In addition, subdivision may be performed recursively on an edge where a subdivision vertex and a base mesh vertex are connected. In other words, subdivision may be performed recursively on an edge where base mesh vertices are connected and/or an edge where subdivision vertices are connected. Then, the 3D position of a base mesh may be modified based on the 3D position values (or coordinates) of a base mesh vertex and one or more subdivision vertices and a reconstructed difference vector transmitted from the inverse transformer. A mesh may be reconstructed through this modification. As an example, the 3D position of a base mesh may be modified by adding the 3D position values of a base mesh vertex and one or more subdivision vertices and a reconstructed difference vector in each vertex unit.

A subdivision value referring to the number of repetitions of the subdivision may be transmitted from an encoding apparatus to a decoding apparatus. A subdivision value may be encoded in a patch unit.

As an example, a patch unit subdivision flag may be obtained from a bitstream. The patch unit subdivision flag may represent whether a subdivision value in a patch unit is used. Alternatively, the patch unit subdivision flag may represent whether a subdivision value encoded in a patch unit is parsed from a bitstream. When the value of the patch unit subdivision flag is 1, a subdivision value encoded in a patch unit may be parsed from a bitstream. On the other hand, when the value of a patch unit subdivision flag is 0, a sub-block value in a frame unit may be used as the subdivision value of a current patch. Table 1 below is an example of the semantics of a subdivision value and a syntax for decoding a subdivision value.

TABLE 1

| | Descriptor |
|---|---|
| mesh_intra_data_unit( tileID, patchIdx ) { | |
| ... | |
| if(mdu_patch_parameters_enable_flag){ | |
| mdu_subdivision_enable_flag[ tileID ][ patchIdx ] | u(1) |
| ... | |
| } | |
| ... | |
| if(mdu_subdivision_enable_flag[ tileID ][ patchIdx ]){ | |
| mdu_subdivision_method[ tileID ][ patchIdx ] | u(3) |
| mdu_subdivision_iteration_count[ tileID ][ patchIdx ] | u(8) |
| } | |
| ... | |

TABLE 2
mdu_subdivision_iteration_count[ tileID ][ patchIdx ] indicates the number of iterations used
for the subdivision in a patch with index patchIdx of the current atlas tile, with tile ID equal to
tileID. When mdu_subdivision_iteration_count[ tileID ][ patchIdx ] is not present, its values is
inferred to be equal to afps_vmc_ext_subdivision_iteration_count.

A subdivision value may be changed according to the importance of a patch. In other words, a subdivision value may be changed adaptively according to the classification, type, attribute, etc. of a patch. As an example, a patch expressing a part such as a human face may express the details of a face by performing a relatively large number of subdivisions. Conversely, for a flat part such as a human back, it may perform a relatively small number of subdivisions. In this case, an encoding apparatus and a decoding apparatus may derive a subdivision value in the same manner without signaling in a patch unit. In addition, as the position and size of a patch on a 3D space are similar, the encoding/decoding order of a patch may be close. In addition, when the encoding/decoding order of a patch is close, a subdivision structure may be relatively more similar. Accordingly, it may be more efficient to encode a subdivision value by using a delta subdivision value.

As an example, when a subdivision value representing the number of subdivisions is determined in a patch unit, the triangle of a base mesh within a corresponding patch may be subdivided as many times as the maximum number of subdivisions determined above. In other words, when the subdivision value of a current patch is determined (or signaled) as 2, the triangle of a base mesh within a current patch may be recursively/hierarchically subdivided up to two times. In this case, the number of subdivisions may be determined for each triangle included in a base mesh within the range of the number of subdivisions in a patch unit. In other words, the number of subdivisions determined in a patch unit may be the maximum number of subdivisions.

Alternatively, when a subdivision value representing the number of subdivisions is determined in a patch unit, all triangles of a base mesh within a corresponding patch may be subdivided as many times as the number of subdivisions determined in a patch unit.

Alternatively, for the first patch of a current frame, a subdivision value may be transmitted from an encoding apparatus to a decoding apparatus. After parsing all current patch information, a current subdivision value may be stored. Then, for subsequent patches, a delta subdivision value (delta_subdivisions) with a previous patch may be transmitted from an encoding apparatus. A subdivision value for a current patch may be derived by adding the pre-stored subdivision value of a previous patch and the transmitted delta subdivision value.

The delta subdivision value may be a difference value between a specific patch within a frame (e.g., the first patch in encoding/decoding order) and the subdivision value of a current patch. Alternatively, a delta subdivision value may be a difference value between the subdivision values of a current patch and an immediately previous patch in the encoding/decoding order of patches within a frame.

Alternatively, for the first patch of a current frame, a subdivision value may be transmitted from an encoding apparatus to a decoding apparatus. After parsing all current patch information, a current subdivision value may be stored. Then, for subsequent patches, the delta subdivision value (delta_subdivisions) of a previous patch may be transmitted from an encoding apparatus. A subdivision value for a current patch may be derived by adding the pre-stored subdivision value of a previous patch and the delta subdivision value. In this case, a delta subdivision flag (delta_subdivisions_flag) may be parsed before parsing a delta subdivision value. When the value of a delta subdivision flag is 1, a delta subdivision value may be parsed. In this case, a subdivision value for a current patch may be derived by adding the pre-stored subdivision value of a previous patch and the delta subdivision value. On the other hand, when the value of a delta subdivision flag is 0, a delta subdivision value may be considered as 0. In this case, a pre-stored subdivision value may be derived as a subdivision value for a current patch. Tables 3 and 4 below are an example of a syntax where a delta subdivision value is signaled.

TABLE 3

Descriptor

```
patch_information_data( tileID, patchIdx, patchMode ) {
  if( patchMode == S_MESH )
    skip_mesh_patch_data_unit( )
  else if( patchMode == M_MESH )
    merge_mesh_patch_data_unit( tileID, patchIdx )
  else if( patchMode == P_MESH )
    inter_ mesh_patch_data_unit( tileID, patchIdx )
  else if( patchMode == I_MESH ) {
    intra_mesh_patch_data_unit( tileID, patchIdx )
    prv_mdu_subdivision_iteration_count = mdu_subdivision_iteration_count[ tileID ][ patchIdx]
  }
  else if( patchMode == R_MESH )
    raw_ mesh_patch_data_unit( tileID, patchIdx )
}
```

TABLE 4

| | Descriptor |
|---|---|
| intra_mesh_patch_data_unit( tileID, patchIdx ) { | |
| ... | |
| if(mdu_patch_parameters_enable_flag){ | |
| mdu_subdivision_enable_flag[ tileID ][ patchIdx ] | u(1) |
| if(mdu_subdivision_enable_flag[ tileID ][ patchIdx ]) | |
| mdu_delta_subdivision_enable_flag[ tileID ][ patchIdx ] | u(1) |
| ... | |
| } | |
| ... | |
| if(mdu_subdivision_enable_flag[ tileID ][ patchIdx ]){ | |
| mdu_subdivision_method[ tileID ][ patchIdx ] | u(3) |
| if(mdu_delta_subdivision_enable_flag[ tileID ][ patchIdx ]){ | |
| mdu_delta_subdivision_iteration_count[tileID ][ patchIdx ] | u(8) |
| mdu_subdivision_iteration_count[ tileID ][ patchIdx] = prv_mdu_subdivision_iteration_count + | |
| mdu_delta_subdivision_iteration_count[tileID ][ patchIdx ] | |
| } | |
| } | |
| ... | |

A subdivision value may be used differently for each triangle of a patch. A static mesh decoder may sequentially decode a triangle in predetermined encoding/decoding order. As an example, the encoding/decoding order of triangles may be determined based on an edge-breaker algorithm. Based on the encoding/decoding order, delta coding may be applied to a subdivision value in a triangle unit. Tables 5 and 6 below are an example of a syntax for using a different subdivision value in a triangle unit. Information representing whether to use a subdivision value differently in a triangle unit may be parsed, and a delta subdivision value may be parsed in a triangle unit based on the value of corresponding information. In this case, a subdivision value for a current triangle may be derived by adding a delta subdivision value parsed for a current triangle to the subdivision value of a triangle with previous encoding/decoding order. Information representing whether to use a subdivision value differently in a triangle unit may be encoded for each patch. In other words, any one of a plurality of patches may use a different subdivision value for a triangle constituting a corresponding patch, and another may use the same subdivision value for a triangle constituting a corresponding patch.

TABLE 5

| | Descriptor |
|---|---|
| intra_mesh_patch_data_unit( tileID, patchIdx ) { | |
| ... | |
| if(mdu_subdivision_enable_flag[ tileID ][ patchIdx ]){ | |
| mdu_subdivision_method[ tileID ][ patchIdx ] | u(3) |
| mdu_subdivision_iteration_count[ tileID ][ patchIdx ] | u(8) |
| mdu_enable_delta_face_subdivision_flag[ tileID ][ patchIdx ] | U(1) |
| } | |
| ... | |
| } | |

TABLE 6

| | Descriptor |
|---|---|
| mesh_face_data_unit( tileID, patchIdx, faceIdx ) { | |
| ... | |
| if(mdu_enable_delta_face_subdivision_flag[ tileID ][ patchIdx ]){ | |
| mdu_delta_face_subdivision_iteration_count[tileID ][ patchIdx ][faceIdx] | u(8) |
| mdu_face_subdivision_iteration_count[ tileID ][ patchIdx][faceIdx] = | |
| pred_subdivision + mdu_delta_face_subdivision_iteration_count[tileID ][ patchIdx ][faceIdx] | |
| } | |
| pred_subdivision = mdu_face_subdivision_iteration_count[ tileID ][ patchIdx][faceIdx] | |
| ... | |
| } | |

One or more neighboring triangles may be adjacent to a current triangle in the encoding/decoding order of triangles. In this case, prediction may be performed on the subdivision value of a current triangle based on the subdivision value of a pre-encoded neighboring triangle. A difference between the original subdivision value of a current triangle and the subdivision value of a neighboring triangle may be transmitted from an encoding apparatus to a decoding apparatus. In other words, the subdivision value of a current triangle may be derived based on the subdivision value of a pre-decoded neighboring triangle and a signaled difference subdivision value. When a current triangle does not have a neighboring triangle, a subdivision value transmitted in a patch unit may be used as a prediction value for the subdivision value of a current triangle. Alternatively, when a current triangle has one neighboring triangle, the subdivision value of a corresponding neighboring triangle may be used as a prediction value. When a current triangle has two or more neighboring triangles, the average of the subdivision values of two or more neighboring triangles may be used as a prediction value. Table 7 below is an example of a method for deriving a prediction value for the subdivision value of a current triangle based on the number of neighboring triangles adjacent to a current triangle.

TABLE 7

| | Descriptor |
|---|---|
| mesh_face_data_unit( tileID, patchIdx, faceIdx ) { | |
| ... | |
| if(mdu_enable_delta_face_subdivision_flag[ tileID ][ patchIdx ]){ | |
| mdu_delta_face_subdivision_iteration_count[tileID ][ patchIdx ][faceIdx] | u(8) |
| if (nb_faces == 0) | |
| pred_subdivision = mdu_subdivision_iteration_count[ tileID ][ patchIdx] | |
| else if (nb_faces == 1) | |
| pred_subdivision = nb0_subdivision | |
| else if (nb_faces == 2) | |
| pred_subdivision = (nb0_subdivision + nb1_subdivision+1)>>1 | |
| mdu_face_subdivision_iteration_count[ tileID ][ patchIdx][faceIdx] = | |
| pred_subdivision + mdu_delta_face_subdivision_iteration_count[tileID ][ patchIdx ][faceIdx] | |
| } | |
| ... | |
| } | |

To obtain a prediction value for the subdivision value of a current triangle, the number of pre-reconstructed neighboring triangles adjacent to a current triangle may be confirmed. If the number of neighboring triangles is 0, the subdivision value of a patch including a current triangle may be used as a prediction value. If the number of neighboring triangles is 1, the subdivision value of a corresponding triangle may be used as a prediction value. If the number of neighboring triangles is 2, information (nb_pred_flag) representing the position of a neighboring triangle with a prediction value for the subdivision value of a current triangle may be parsed. If the value of parsed information is 0, the subdivision value of the first neighboring triangle may be used as a prediction value. On the other hand, if the value of the information is 1, the subdivision value of the second neighboring triangle may be used as a prediction value. Here, the first neighboring triangle may refer to a triangle adjacent to an edge connected to the left of a reference edge, and the second neighboring triangle may refer to a triangle adjacent to an edge connected to the right of a reference edge. Alternatively, the first neighboring triangle may refer to a triangle adjacent to an edge connected to the right of a reference edge, and the second neighboring triangle may refer to a triangle adjacent to an edge connected to the left of a reference edge. As an example, a syntax as shown in Table 8 below may be used.

TABLE 8

| | Descriptor |
|---|---|
| mesh_face_data_unit( tileID, patchIdx, faceIdx ) { | |
| ... | |
| if(mdu_enable_delta_face_subdivision_flag[ tileID ][ patchIdx ]){ | |
| mdu_delta_face_subdivision_iteration_count[tileID ][ patchIdx ][faceIdx] | u(8) |
| if (nb_faces == 0) | |
| pred_subdivision = mdu_subdivision_iteration_count[ tileID ][ patchIdx] | |
| else if (nb_faces == 1) | |
| pred_subdivision = nb0_subdivision | |
| else if (nb_faces == 2) { | |
| if (nb_faces > 1) | |
| mdu_nb_pred_flag[ tileID ][ patchIdx ][faceIdx] | U(1) |
| if (mdu_nb_pred_flag[ tileID ][ patchIdx ][faceIdx] == 0) | |
| pred_subdivision = nb0_subdivision | |
| else | |
| pred_subdivision = nb1_subdivision | |
| } | |
| mdu_face_subdivision_iteration_count[ tileID ][ patchIdx][faceIdx] = | |
| pred_subdivision + mdu_delta_face_subdivision_iteration_count[tileID ][ patchIdx ][faceIdx] | |
| } | |
| ... | |
| } | |

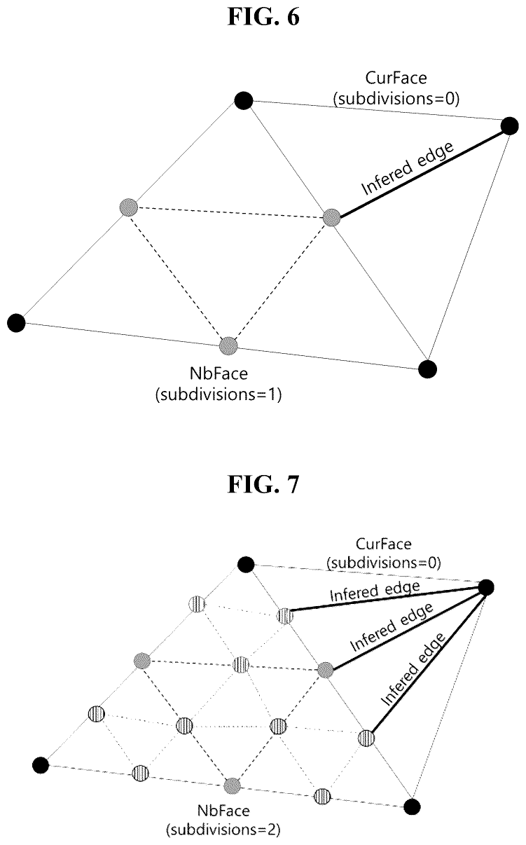

FIG. 6 illustrates a case in which the subdivision value of a current triangle is smaller than the subdivision value of a neighboring triangle.

FIG. 6 is an example of a case in which the subdivision value of a current triangle is smaller than the subdivision value of a neighboring triangle by 1.

Subdivision may be performed on a current triangle based on the derived subdivision value in a patch unit. In this case, when the subdivision value of a current triangle is different from the subdivision value of a neighboring triangle, a triangle may be additionally divided to generate an edge and a triangle.

As in the example of FIG. 6, when a current triangle has one neighboring triangle and the subdivision value of a current triangle is smaller than the subdivision value of a neighboring triangle, a current triangle may be divided into two triangles by generating an edge that connects vertices adjacent to a current triangle among the first subdivision vertices of a neighboring triangle and one vertex located diagonally from corresponding vertices in a current triangle.

FIG. 7 illustrates a case in which the subdivision value of a current triangle is smaller than the subdivision value of a neighboring triangle.

FIG. 7 is an example of a case in which the subdivision value of a current triangle is smaller than the subdivision value of a neighboring triangle by 2.

As in the example of FIG. 7, when a current triangle has one neighboring triangle and the subdivision value of a current triangle is smaller than the subdivision value of a neighboring triangle by 2, a current triangle may be divided into a plurality of triangles by generating multiple edges that connect vertices adjacent to a current triangle among the first subdivision vertices and the second subdivision vertices of a neighboring triangle and a vertex located diagonally from corresponding vertices in a current triangle.

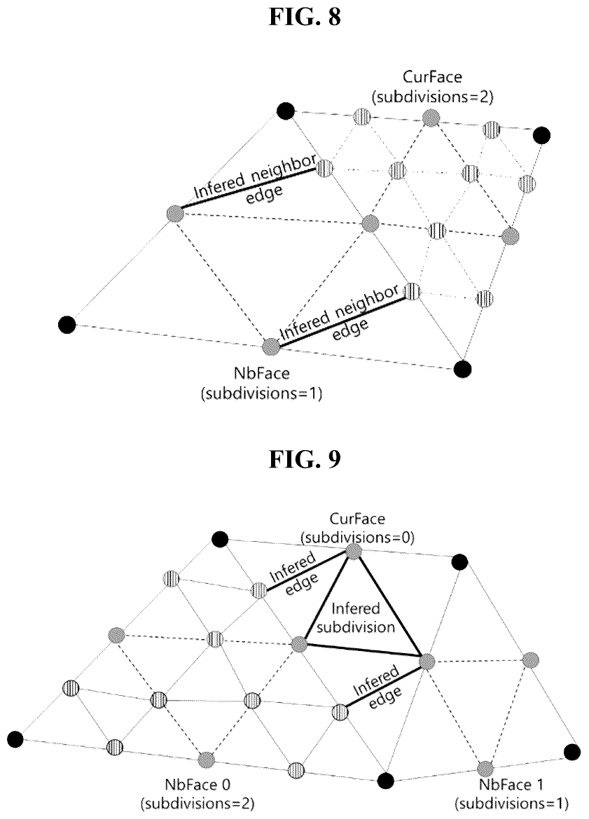

FIG. 8 illustrates a case in which the subdivision value of a current triangle is greater than the subdivision value of a neighboring triangle.

FIG. 8 is an example of a case in which the subdivision value of a current triangle is greater than the subdivision value of a neighboring triangle by 1.

When the subdivision value of a current triangle is greater than the subdivision value of a neighboring triangle, a neighboring triangle may be additionally divided.

As in the example of FIG. 8, when a current triangle has one neighboring triangle and the subdivision value of a current triangle is greater than the subdivision value of a neighboring triangle by 1, a neighbor triangle may be divided by generating an edge by connecting the second subdivision vertices of a current triangle adjacent to a neighboring triangle and the first subdivision vertices not adjacent to a current triangle among the first subdivision vertices of a neighboring triangle.

FIG. 9 illustrates a case in which there are two neighboring triangles and the subdivision value of a current triangle is smaller than the subdivision value of a neighboring triangle.

FIG. 9 is an example of a case in which there are two neighboring triangles and the subdivision value of a current triangle is smaller than the subdivision value of a neighboring triangle.

As in FIG. 9, when the subdivision value of a current triangle is smaller than the subdivision value of a neighboring triangle, a current triangle may be additionally subdivided into four faces, and then may be additionally divided into two faces by generating an edge.

Here, additional subdivision may be performed by a difference between the minimum value of the subdivision values of a neighboring triangle and the subdivision value of a current triangle. Afterwards, additional division using an edge may be performed.

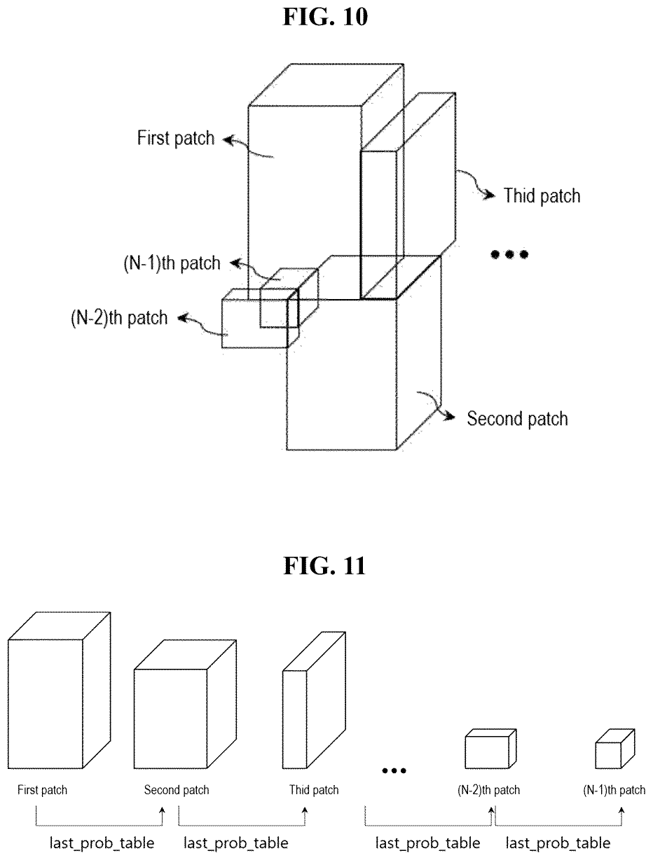

FIG. 10 illustrates a 3D patch divided into various sizes.

A dynamic mesh is generally data expressing the surface of a 3D object. In this case, as shown in the example of FIG. 10, the surface of a 3D object may be divided into one or more patches. The size of each patch may vary depending on the attribute information of a surface. Alternatively, the size of a patch may be determined differently by the surface curvature of a 3D object or a user parameter. In addition, an adjacent patch may have the same/similar attribute information and motion information.

FIG. 11 illustrates a method for initializing a probability table in a patch unit in a static mesh decoder according to the present disclosure.

The static mesh decoder may decode a base mesh based on patch information signaled through the higher level of a bitstream. Decoding of a base mesh may be performed in the order of patch indices. The coordinates of the 3D vertex, the coordinates of the 2D vertex and the triangle of a base mesh corresponding to each patch may be reconstructed.

As shown in the example of FIG. 11, probability values for entropy decoding at a time point when decoding for one patch is terminated may be stored and used in the next patch. In this case, probability values for all symbols may be stored in the form of a table, and there may be a plurality of probability values according to the context for one symbol.

For consecutive patches, a probability value stored for a current patch may be used as the initial probability value of the next patch, performing entropy decoding on the symbols of a patch. An encoding apparatus may generally determine the order of patches based on the size and adjacency of patches. Accordingly, since patch indices have a similar probability value as they are adjacent, symbol compression may be performed with higher efficiency.

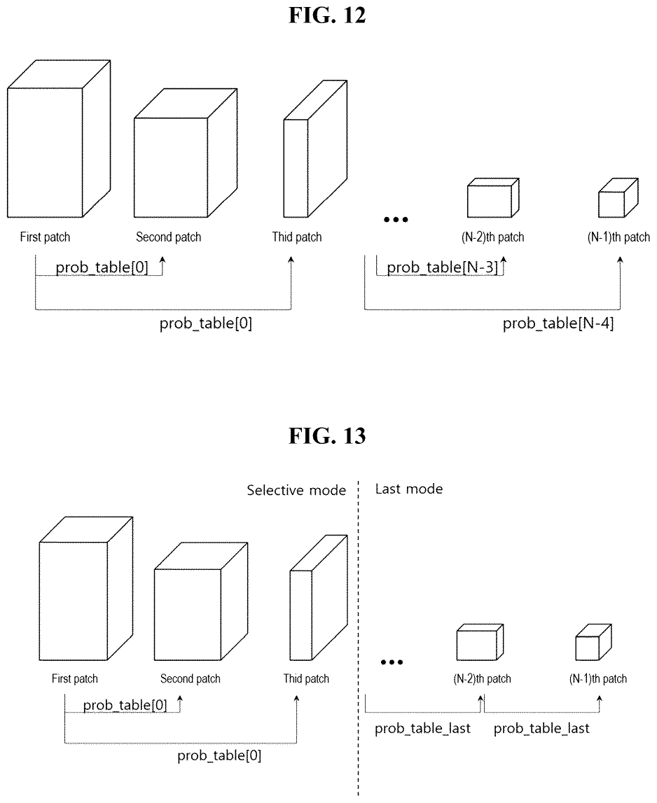

FIG. 12 illustrates a method for initializing an optional probability table in a patch unit in a static mesh decoder according to the present disclosure.

Referring to FIG. 12, the probability values of the entropy decoder may be stored after decoding for one patch is terminated, and the stored probability values may be used as an initial probability value in a subsequent patch. In this case, a probability table stored in any one of the pre-reconstructed patches may be used as the initial probability table of a current patch.

As an example, any one of the pre-reconstructed patches may be selected based on reference patch index information signaled from an encoding apparatus in a patch unit.

Alternatively, any one of the pre-reconstructed patches may be selected based on the position information of a patch. A probability table stored in the closest patch on a 3D space among the pre-reconstructed patches may be used as the initial probability table of a current patch.

Alternatively, any one of the pre-reconstructed patches may be selected based on the size information of a patch. A probability table stored in the patch of the most similar size to a current patch among the pre-reconstructed patches may be used as the initial probability table of a current patch.

Alternatively, any one of the pre-reconstructed patches may be selected based on the value of any one of the width, height and depth of a patch. A probability table stored in a patch where the value is most similar to a current patch among the pre-reconstructed patches may be used as the initial probability table of a current patch. Here, the value of any one of the width, height and depth of a patch may be defined as the largest value or the smallest value among the width, height and depth of a patch. Alternatively, it may be defined as the average value of at least two of the width, height or depth of a patch.

Alternatively, any one of the pre-reconstructed patches may be selected based on the vertex density of a base mesh within a patch. A probability table stored in a patch with the most similar density to a current patch among the pre-reconstructed patches may be used as the initial probability table of a current patch.

Alternatively, any one of the pre-reconstructed patches may be selected based on the number of vertices of a base mesh within a patch. A probability table stored in a patch where the number of vertices of a base mesh within a patch is most similar to a current patch among the pre-reconstructed patches may be used as the initial probability table of a current patch.

FIG. 13 illustrates a method for initializing an adaptive probability table in a patch unit in a static mesh decoder according to the present disclosure.

Referring to FIG. 13, the probability value of the entropy decoder may be stored after decoding for one patch is terminated, and the stored probability value may be used as an initial probability value in a subsequent patch.

A probability table stored in a patch specified by reference patch index information signaled from an encoding apparatus in a patch unit among the pre-reconstructed patches may be used as the initial probability table of a current patch.

Based on an attribute such as the position, size, density or number of vertices of the base mesh of a patch, a probability table stored in a patch with the most similar attribute to a current patch among the pre-reconstructed patches may be used as the initial probability table of a current patch.

As an example, after a specific patch index, a probability table stored in a previous patch may be selectively used as the initial probability table of a current patch.

Here, a specific patch index may be signaled in a frame unit. Alternatively, a specific patch index may be determined as the index of the first patch whose patch size is smaller than a specific value. In this case, the size of a reference patch may be any one of the width, height or depth.

Alternatively, after a specific patch index, a probability table pre-defined equally in an encoding apparatus and a decoding apparatus may be used as the initial probability table of a current patch. In other words, a selective mode may be defined in which the probability table of a patch having the first specific patch index is selectively used as the initial probability table of a current patch. Alternatively, a last mode may be defined in which the probability table of a previous patch in encoding/decoding order is used as the initial probability table of a current patch. The first specific patch index used in a selective mode may be determined by a method described above.

As illustrated in FIG. 13, any one of a selective mode or a last mode may be selectively used based on the second specific patch index. For example, as illustrated in FIG. 13, a selective mode may be applied up to a patch having the second specific patch index, and a last mode may be applied after a patch having the second specific patch index. Alternatively, a last mode may be applied up to a patch having the second specific patch index, and a selective mode may be applied after a patch having the second specific patch index. The second specific patch index may be a value signaled separately or may be a value determined according to encoding information pre-defined in an encoding/decoding apparatus. For example, the second specific patch index may be the index of a patch with the smallest index value among the patches smaller than (or, smaller than or equal to) a specific size.

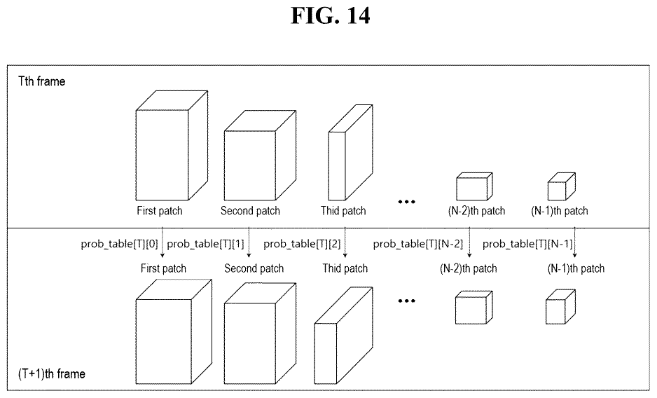

FIG. 14 illustrates a method for referring to a probability table in a patch unit in a static mesh decoder according to the present disclosure.

Referring to FIG. 14, a probability table stored after decoding for one patch is terminated may be used in the next frame. Here, when inter prediction is performed on the (T+1)th frame, a probability table stored in a patch with the same patch index may be used as the initial probability table of a current patch.

Alternatively, a flag representing whether to use the probability table of a reconstructed patch within a current frame or whether to use the probability table of another reconstructed frame may be signaled in a patch unit, and a probability table may be initialized by selecting one method according to a corresponding flag. When it is determined to use another reconstructed frame, information about a frame to be referenced may be additionally signaled, and the probability table of a frame specified by corresponding information may be used as the initial probability table of a current patch.

When a current frame and a reference frame have a different number of patches, information about a patch index may be additionally signaled, and the probability table of a patch specified by corresponding information may be used as the initial probability table of a current patch. Conversely, when a current frame and a reference frame have the same number of patches, the probability table of a patch with the same index as the patch index of a current patch within a reference frame may be used as the initial probability table of a current patch.

The various embodiments of the present disclosure do not list all possible combinations, but are intended to describe the representative aspect of the present disclosure, and matters described in various embodiments may be applied independently or in a combination of at least two.

In addition, the various embodiments of the present disclosure may be implemented by hardware, firmware, software or a combination thereof. For implementation by hardware, they may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

The scope of the present disclosure includes software or machine-executable instructions (i.e., an operating system, an application, firmware, a program, etc.) that enable operations according to the methods of various embodiments to be executed on a device or a computer, and a non-transitory computer-readable medium in which such software or instructions are stored and executable on a device or a computer.

1. A mesh decoding method, comprising:
receiving a bitstream, wherein the bitstream includes one or more sub-bitstreams, and the one or more sub-bitstreams include at least one of a sub-bitstream regarding a mesh, a sub-bitstream regarding a difference vector transform coefficient, or a sub-bitstream regarding a texture map;
reconstructing a base mesh of a current patch by decoding the sub-bitstream regarding the mesh;
reconstructing a difference vector by decoding the sub-bitstream regarding the difference vector transform coefficient; and
reconstructing a mesh of the current patch based on at least one of the base mesh or the difference vector.

2. The method of claim 1, wherein reconstructing the mesh of the current patch includes performing subdivision on the reconstructed base mesh based on a predetermined subdivision value, and
wherein the subdivision value represents a number of the subdivisions.

3. The method of claim 2, wherein the subdivision value is signaled in a patch unit from the bitstream.

4. The method of claim 3, wherein the subdivision value is signaled from the bitstream based on a patch unit subdivision flag, and
wherein the patch unit subdivision flag represents whether a subdivision value in the patch unit is used.

5. The method of claim 2, wherein the subdivision value is derived based on a subdivision value of a previous patch and a delta subdivision value signaled for the current patch.

6. The method of claim 5, wherein the previous patch refers to a first patch in decoding order or a patch having decoding order immediately before the current patch.

7. The method of claim 2, wherein any one of a plurality of triangles belonging to the current patch has a subdivision value different from another one.

8. The method of claim 7, wherein a subdivision value of a current triangle among the plurality of triangles is derived based on a subdivision value of a neighboring triangle adjacent to the current triangle.

9. The method of claim 8, wherein the neighboring triangle is specified based on information signaled from the bitstream, and
wherein the information represents any one of a plurality of neighboring triangles adjacent to the current triangle.

10. The method of claim 1, wherein a probability table stored in any one of pre-reconstructed patches is used as an initial probability table for the current patch.

11. The method of claim 10, wherein the any one of the pre-reconstructed patches is selected based on reference patch index information signaled through the bitstream.

12. The method of claim 10, wherein the any one of the pre-reconstructed patches is a patch having decoding order prior to the current patch.

13. The method of claim 10, wherein the pre-reconstructed patch belongs to a frame different from a current frame to which the current patch belongs, and
wherein the any one of the pre-reconstructed patches is a patch having a same patch index as the current patch.

14. A mesh encoding method, comprising:
generating a sub-bitstream regarding a mesh by encoding a base mesh of a current patch;
generating a sub-bitstream regarding a difference vector transform coefficient by encoding a difference vector; and
generating a bitstream including at least one of the sub-bitstream regarding the mesh, the sub-bitstream regarding the difference vector transform coefficient, or a sub-bitstream regarding a texture map.
